(19) United States
(12) Patent Application Publication
(10) Pub. No.: US 2008/0078064 A1
(43) Pub. Date: Apr. 3, 2008

(54) HINGE STRUCTURE AND FOLDABLE APPARATUS USING THE SAME

(75) Inventor: Chung-Kuo Lai, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/672,520

(22) Filed: Feb. 8, 2007

(30) Foreign Application Priority Data
Sep. 1, 2006 (TW) 95132308

(51) Int. Cl. E05D 5/02

(52) U.S. Cl. 16/387

(57) ABSTRACT

A hinge structure set between a first casing and a second casing of a foldable apparatus such that the first casing is capable of being rotated relative to the second casing is provided. The foldable apparatus has a cable that extends from the inside of the first casing to the inside of the second casing by passing through the hinge structure. The hinge structure includes a hinge member and a supporting member. The hinge member is connected to the first casing. The supporting member is connected between the hinge member and the second casing, and has a cable channel that extends from the inside of the second casing to the outside thereof by passing through a through hole of the second casing for receiving a section of the cable. The cable can pass through the hinge structure so that the volume of the foldable apparatus using the same is decreased.

### CROSS-REFERENCE TO RELATED APPLICATION

This application claims the priority benefit of Taiwan application serial no. 95132308, filed Sep. 1, 2006. All disclosure of the Taiwan application is incorporated herein by reference.

### BACKGROUND OF THE INVENTION

1. Field of the Invention

The present invention relates to a hinge structure, and more particularly to a hinge structure that combines with a cable and a foldable apparatus using the same.

2. Description of Related Art

Because a mobile computer has an identical function as a common desktop computer and a volume and weight trimmed down for portability, mobile computer has become an indispensable tool for carrying around by some users. At present, the most common type of mobile computer is the notebook computer.

With the continuous lowering of the price of a notebook computer, some users directly replace their desktop computer with notebook computers. Moreover, with the emergence of the wireless network, the notebook computer is no longer constrained by the need for a network cable connection. Thus, the notebook computer can fully enjoy the convenience of networking anywhere within a wireless network covered area.

A notebook computer provides a user with a keyboard and a display. However, subjected to the constraints of inherent conditions of the user, the keyboard and the display cannot be overly miniaturized. Therefore, to reduce the volume, the notebook computer uses a foldable design.

In general, a notebook computer has a system base having a keyboard thereon and a display having a side edge hinged to a side edge of the system base. Consequently, the user may flip the notebook computer open like flipping a book and expand the display out from the keyboard side of the system base or close the display back on the keyboard side of the system base.

A notebook computer normally uses two hinge structures to pivot a display to its system base. The two hinge structures are generally separated from each other by a distance and set on a side edge of the display adjacent to the system base. Furthermore, the two ends of these two hinge structures are located at the junction between the system base and the display. Therefore, signal cables may pass from the inside of the system base through one of the two ends of a hinge structure and extend to the inside of the display while a hinge member is set up on the other side of the two ends of the hinge structure.

However, when the two hinge structures are set up on the display adjacent to the two corners of the system base, only one end of the two ends of each hinge structure is located at the junction between the system base and the display. The other end must be sealed so that wiring a cable is impossible. As a result, after setting the hinge member on that end of the hinge structure, the signal cable must find other path extending from the inside of the system base to the inside of the display.

### SUMMARY OF THE INVENTION

Accordingly, the present invention is directed to a hinge structure that allows a cable to pass through the hinge structure.

The present invention is also directed to a hinge structure set up between two casing of a foldable apparatus that allows a cable of the foldable apparatus to pass through, thereby decreasing the volume of the foldable apparatus.

The present invention is also directed to a foldable apparatus that allows a cable to pass through a hinge structure.

The present invention is also directed to a foldable apparatus having a hinge structure set up between two casing that allows a cable to pass through the hinge structure, thereby decreasing the volume of the foldable apparatus.

To achieve these and other advantages, as embodied and broadly described herein, the invention provides a hinge structure suitable for being set between a first casing and a second casing of a foldable apparatus such that the first casing is capable of being rotated relative to the second casing. The foldable apparatus has a cable that extends from the inside of the first casing to the inside of the second casing by passing through the hinge structure. The hinge structure includes a hinge member and a supporting member. The hinge member is connected to the first casing. The supporting member is connected between the hinge member and the second casing, and has a cable channel that extends from the inside of the second casing to the outside thereof by passing through a through hole of the second casing for receiving a section of the cable.

The present invention also provides a foldable apparatus comprising a first casing, a second casing, a cable and a hinge structure. The hinge structure is set between the first casing and the second casing such that the first casing is capable of being rotated relative to the second casing. Furthermore, the cable extends from the inside of the first casing to the inside of the second casing by passing through the hinge structure. The hinge structure includes a hinge member and a supporting member. The hinge member is connected to the first casing and has a hinge axis. The supporting member is connected between the hinge member and the second casing, and has a cable channel that extends from the inside of the second casing to the outside thereof by passing through a through hole of the second casing for receiving a section of the cable. Furthermore, the portion of the cable accommodated inside the cable channel and substantially parallel to the hinge member has aforesaid hinge axis.

The present invention also provides a hinge structure suitable for setting between a first casing and a second casing of a foldable apparatus such that the first casing is capable of being rotated relative to the second casing. The foldable apparatus has a cable that extends from the inside of the first casing to the inside of the second casing by passing through the hinge structure. The hinge structure includes a hinge member and a supporting member. The hinge member is connected to the first casing and includes a spindle with a local section having a recess to form a first cable channel. The first cable channel extends from the outside of the second casing to the inside thereof by passing through a through hole of the second casing for receiving a section of the cable. The supporting member is connected between the hinge member and the second casing.

The present invention also provides a foldable apparatus comprising a first casing, a second casing, a cable and a hinge structure. The hinge structure is set between the first casing and the second casing such that the first casing is capable of being rotated relative to the second casing. Furthermore, the cable extends from the inside of the first casing to the inside of the second casing by passing through the hinge structure. The hinge structure includes a hinge member and a supporting member. The hinge member is connected to the first casing and includes a spindle with a local section having a recess to form a first cable channel. The first cable channel extends from the outside of the second casing to the inside thereof by passing through a through hole of the second casing for receiving a section of the cable. The supporting member is connected between the hinge member and the second casing.

Accordingly, by forming a cable channel in the hinge member and/or the supporting member of the hinge structure in the present invention, a cable is able to extend from one casing to another casing of the foldable apparatus by passing through the hinge structure. Therefore, the volume of the foldable apparatus is reduced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a foldable apparatus according to a first embodiment of the present invention.

FIG. 2 is an enlarged view of the area E of FIG. 1.

FIG. 3 is a perspective view of the hinge structure of FIG. 1.

FIG. 4 is a schematic diagram of a foldable apparatus according to a second embodiment of the present invention.

FIG. 5 is an enlarged view of the area F of FIG. 4.

FIG. 6 is a perspective view of the hinge structure of FIG. 4.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

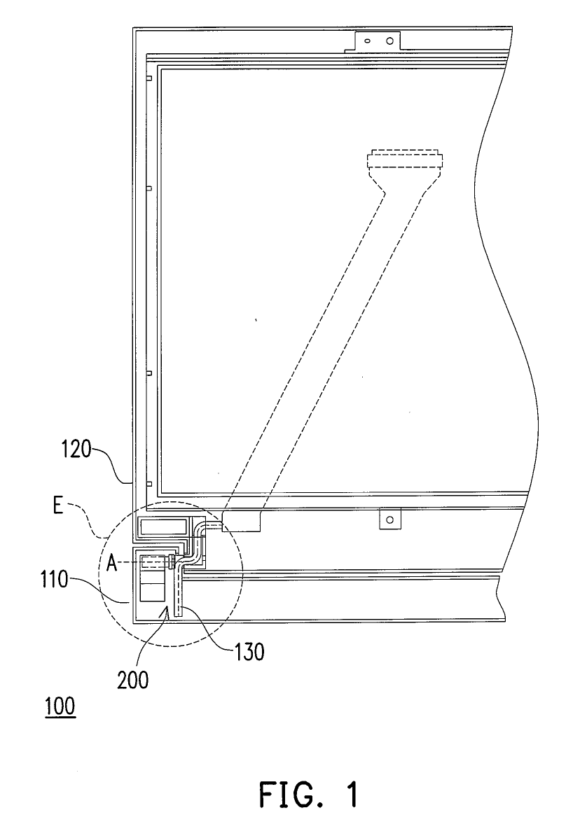

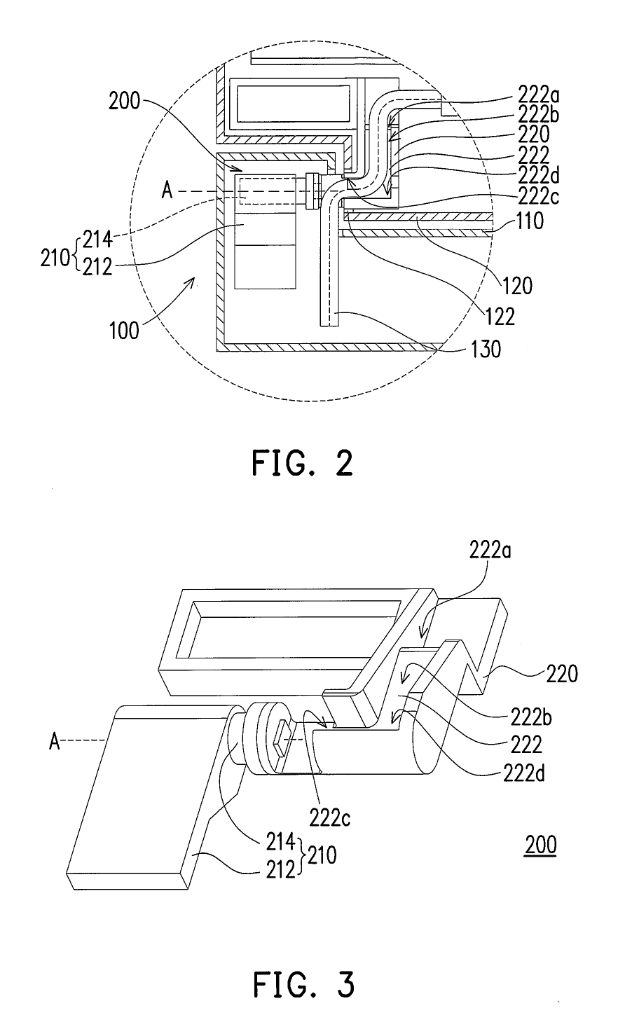

FIG. 1 is a schematic diagram of a foldable apparatus according to a first embodiment of the present invention. FIG. 2 is an enlarged view of the area E of FIG. 1. FIG. 3 is a perspective view of the hinge structure of FIG. 1. As shown in FIGS. 1 through 3, the foldable apparatus 100 of the first embodiment includes a first casing 110, a second casing 120, a cable 130 and a hinge structure 200. When the foldable apparatus 100 is a notebook computer, the cable 130 is a display signal cable.

The hinge structure 200 is set up between the first casing 110 and the second casing 120 such that the first casing 110 is capable of being rotated relative to the second casing 120. Furthermore, the cable 130 extends from the inside of the first casing 110 to the inside of the second casing 120 by passing through the hinge structure 200.

The hinge structure 200 includes a hinge member 210 and a supporting member 220. The hinge member 210 is connected to the first casing 110 and has a hinge axis A. The supporting member 220 is connected between the hinge member 210 and the second casing 120.

In the first embodiment, the hinge member 210 may include a bearing 212 and a spindle 214. The bearing 212 is set up in the first casing 110. Furthermore, the spindle 214 fits the bearing 212 and is connected to the supporting member 220. For example, the spindle 214 may be riveted to the supporting member 220 and the riveting point is located outside the second casing 120.

In order to permit the passing of the cable 130, the supporting member 220 has a cable channel 222. The cable channel 222 extends from the inside of the second casing 120 to the outside of the second casing 120 by passing through a through hole 122 of the second casing 120 for receiving a section of the cable 130.

In the first embodiment, the cable channel 222 includes a first opening 222a, a recess slot 222b and a second opening 222c. Furthermore, the cable 130 sequentially passes through the first opening 222a, the recess slot 222b and the second opening 222c and extends to the outside of the second casing 120. In addition, a central axis of the second opening 222c is substantially parallel to the hinge axis A. Moreover, the cable channel 222 may have one or more bends 222d so that the cable 130 within the cable channel 222 has to bend in these bends 222d.

It should be noted that the portion of the cable 130 accommodated inside the cable channel 222 and running substantially parallel to the hinge member 210 also has a hinge axis identical to the hinge axis A of the hinge member 210. In other words, that portion of the cable 130 can substantially rotate along the hinge axis A following the movement of the hinge member 210 (the spindle 214).

### Second Embodiment

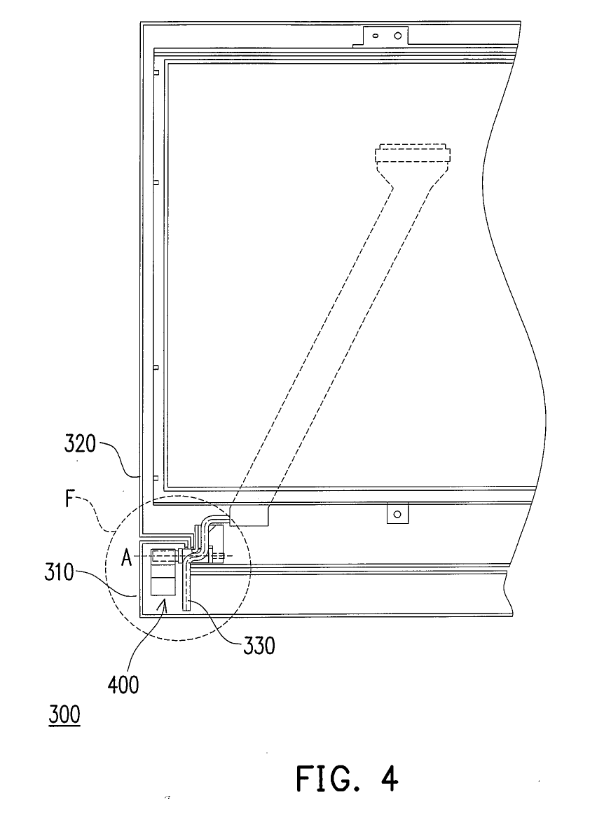

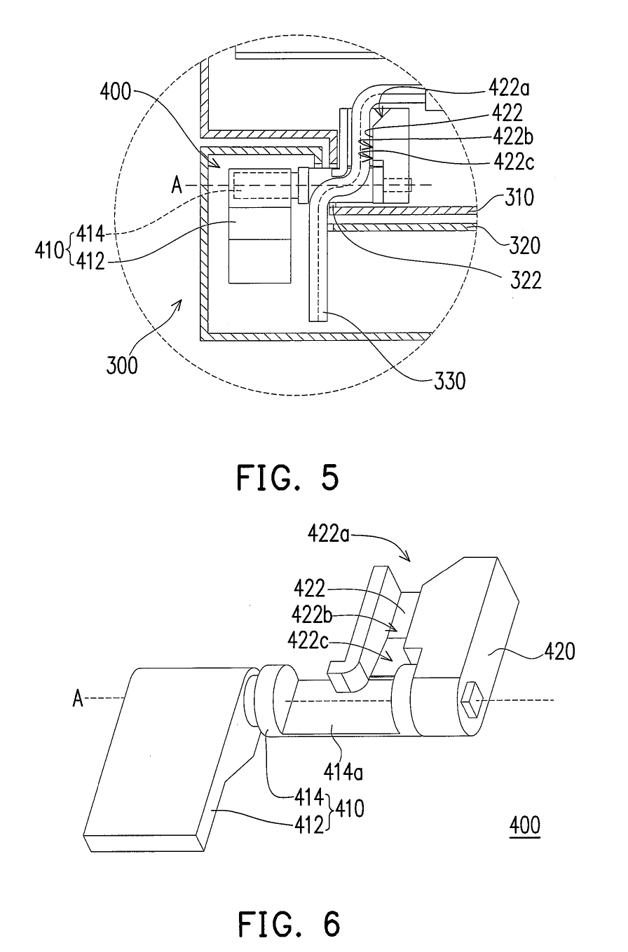

FIG. 4 is a schematic diagram of a foldable apparatus according to a second embodiment of the present invention. FIG. 5 is an enlarged view of the area F of FIG. 4. FIG. 6 is a perspective view of the hinge structure of FIG. 4. As shown in FIGS. 4 through 6, the foldable apparatus 300 in the second embodiment includes a first casing 310, a second casing 320, a cable 330 and a hinge structure 400. When the foldable apparatus 300 is a notebook computer, the cable 330 is a display signal cable.

The hinge structure 400 is set up between the first casing 310 and the second casing 320 such that the first casing 310 is capable of being rotated relative to the second casing 320. Furthermore, the cable 330 extends from the inside of the first casing 310 to the inside of the second casing 320 by passing through the hinge structure 400.

The hinge structure 400 includes a hinge member 410 and a supporting member 420. The hinge member 410 is connected to the first casing 310. The supporting member 420 is connected between the hinge member 410 and the second casing 320.

In the second embodiment, the hinge member 410 may include a bearing 412 and a spindle 414. The bearing 412 is set up in the first casing 310. Furthermore, the spindle 414 fits the bearing 412 and is connected to the supporting member 420. For example, the spindle 414 may be riveted to the supporting member 420 and the riveting point is located outside the second casing 320.

In order to permit the passing of the cable 330, a local section of the spindle 414 of the hinge member 420 has a recess that forms a first cable channel 414a. The first cable channel 414a extends from the outside of the second casing 320 to the inside of the second casing 320 by passing through a through hole 322 of the second casing 320 for receiving a section of the cable 330.

In the second embodiment, similarly for permitting the passing of the cable 330, the supporting member 420 may include a second cable channel 422 for receiving another section of the cable 330.

The second cable channel 422 includes a first opening 422a, a recess slot 422b and a second opening 422c. Furthermore, the cable 330 sequentially passes through the first opening 422a, the recess slot 422b and the second opening 422c and extends to the first cable channel 414a.

In summary, by forming a cable channel in the hinge member and/or the supporting member of the hinge structure in the present invention, a cable is able to extend from one casing to another casing of the foldable apparatus by passing through the hinge structure.

In addition, because the present invention has a design that allows a cable to pass through the hinge structure, there is no need to form any extra channels for a cable to pass from one casing to another casing of the foldable apparatus. Hence, the volume of the foldable apparatus is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hinge structure for setting between a first casing and a second casing of a foldable apparatus such that the first casing is capable of being rotated relative to the second casing and the foldable apparatus has a cable that extends from the inside of the first casing to the inside of the second casing by passing through the hinge structure, the hinge structure comprising:
a hinge member, connected to the first casing; and
a supporting member, connected between the hinge member and the second casing and having a cable channel that extends from the inside of the second casing to the outside of the second casing through a through hole of the second casing for receiving a section of the cable.

2. The hinge structure of claim 1, wherein the cable channel comprises a first opening, a recess slot and a second opening, and the cable sequentially passes through the first opening, the recess slot and the second opening and extends to the outside of the second casing.

3. The hinge structure of claim 1, wherein the cable channel has at least a bend such that the cable within the cable channel bends at the bend.

4. The hinge structure of claim 1, wherein the hinge member comprises a bearing and a spindle, and the bearing is set in the first casing and the spindle fits the bearing and is connected to the supporting member.

5. The hinge structure of claim 4, wherein the spindle is riveted to the supporting member.

6. A foldable apparatus, comprising:
a first casing;
a second casing;
a cable; and
a hinge structure set up between the first casing and the second casing such that the first casing is capable of being rotated relative to the second casing and the cable extends from the inside of the first casing to the inside of the second casing by passing through the hinge structure, the hinge structure comprising:
a hinge member, connected to the first casing and having a hinge axis; and
a supporting member, connected between the hinge member and the second casing and having a cable channel that extends from the inside of the second casing to the outside of the second casing through a through hole of the second casing for receiving a section of the cable, wherein the portion of the cable accommodated inside the cable channel and running substantially parallel to the hinge member has the same hinge axis.

7. The foldable apparatus of claim 6, wherein the cable channel comprises a first opening, a recess slot and a second opening, and the cable sequentially passes through the first opening, the recess slot and the second opening and extends to the outside of the second casing.

8. The foldable apparatus of claim 7, wherein a central axis of the second opening is substantially parallel to the hinge axis.

9. The foldable apparatus of claim 6, wherein the cable channel has at least a bend such that the cable located inside the cable channel bends at the bend.

10. The foldable apparatus of claim 6, wherein the hinge member comprises a bearing and a spindle, and the bearing is set in the first casing and the spindle fits the bearing and is connected to the supporting member.

11. The foldable apparatus of claim 10, wherein the spindle is riveted to the supporting member.

12. A hinge structure for setting between a first casing and a second casing of a foldable apparatus such that the first casing is capable of being rotated relative to the second casing and the foldable apparatus has a cable that extends from the inside of the first casing to the inside of the second casing by passing through the hinge structure, the hinge structure comprising:
a hinge member, connected to the first casing and comprising a spindle, wherein a section of the hinge member has a recess that forms a first cable channel, the first cable channel extends from the outside of the second casing to the inside of the second casing by passing through a through hole of the second casing for receiving a section of the cable; and
a supporting member, connected between the hinge member and the second casing.

13. The hinge structure of claim 12, wherein the supporting member has a second cable channel for accommodating another section of the cable.

14. The hinge structure of claim 13, wherein the second cable channel comprises a first opening, a recess slot and a second opening, and the cable sequentially passes through the first opening, the recess slot and the second opening.

15. The hinge structure of claim 13, wherein the second cable channel has at least a bend such that the cable inside the second cable channel bends at the bend.

16. The hinge structure of claim 12, wherein the hinge member comprises a bearing set in the first casing, and the spindle fits the bearing and is connected to the supporting member.

17. The hinge structure of claim 16, wherein the spindle is riveted to the supporting member.

18. A foldable apparatus, comprising:
a first casing;
a second casing;
a cable; and
a hinge structure, set between the first casing and the second casing such that the first casing is capable of being rotated relative to the second casing and the cable extends from the inside of the first casing to the inside of the second casing by passing through the hinge structure, the hinge structure comprising:
a hinge member, connected to the first casing and comprising a spindle, wherein a section of the hinge member has a recess that forms a first cable channel, the first cable channel extends from the outside of the second casing to the inside of the second casing by passing through a through hole of the second casing for receiving a section of the cable; and
a supporting member, connected between the hinge member and the second casing.

19. The foldable apparatus of claim 18, wherein the supporting member has a second cable channel for accommodating another section of the cable.

20. The foldable apparatus of claim 19, wherein the second cable channel comprises a first opening, a recess slot and a second opening and the cable sequentially passes through the first opening, the recess slot and the second opening.

21. The foldable apparatus of claim 19, wherein the second cable channel has at least a bend such that the portion of the cable inside the second cable channel bends at the bend.

22. The foldable apparatus of claim 18, wherein the hinge member comprises a bearing set in the first casing, and the spindle fits the bearing and is connected to the supporting member.

23. The foldable apparatus of claim 22, wherein the spindle is riveted to the supporting member.
